(19) United States
(12) Patent Application Publication
(10) Pub. No.: US 2005/0024473 A1
(43) Pub. Date: Feb. 3, 2005

(54) Thermal printer

(75) Inventor: Shigeyuki Kamata, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD.

(21) Appl. No.: 10/890,686

(22) Filed: Jul. 14, 2004

(30) Foreign Application Priority Data
Jul. 17, 2003 (JP) 2003-198719

(51) Int. Cl. B41J 11/00; B41J 2/325

(52) U.S. Cl. 347/220

(57) ABSTRACT

A thermal printer is provided that is capable of automatically adjusting a thermal head properly and of performing high-quality image printing by making the contact pressure of the thermal head on the platen roller uniform. A first elastic member 12 elastically urges a head supporting part 5a on the side of a first arm part 6, and a second elastic member 13 elastically urges the head supporting part 5a on the side of a second arm part 7, at positions equidistant by dimension D from a central position of the head supporting part 5a in its longitudinal direction. The urging force of the first elastic member 12 and the urging force of the second elastic member 13 are different from each other.

### BACKGROUND OF THE INVENTION

1. Field of the Invention

The present invention relates to a head pressure contact mechanism of a thermal printer suitable for allowing a plurality of heat generating elements of a thermal head to selectively generate heat to perform printing on a printing paper based on printing information.

2. Description of the Related Art

A conventional thermal printer 51 will now be described with reference to FIGS. 9 and 10.

A cylindrical platen roller 52 is rotatably supported on the frame side (not shown). Further, above the platen roller 52 is arranged a thermal head 53 comprising a line head capable of moving toward or away from the platen roller 52 and a head supporting member 54 that supports the thermal head 53 so as to be movable toward or away from the platen roller 52.

The head supporting member 54 comprises a first head supporting member 55 having a head supporting part 55a for supporting the thermal head 53 on the underside of the head supporting part 55a, and a second head supporting member 56 having a urging part 56a for elastically urging the head supporting part 55a toward the platen roller 52 via a coil spring 57, which is described later.

An adjusting screw 55g capable of adjusting the deflection of the thermal head 53 is fixed to a central position (a central line M) of the head supporting part 55a in its longitudinal direction.

Further, first and second arm parts 55b and 55c are formed in the first head supporting member 55 to extend in the shape of a circular arc from both ends of the head supporting part 55a to the right side in the drawing. A first supporting hole 55d that is elongated in the vertical direction in the drawing is formed through an end, on the right side in the drawing, of the first arm part 55b. A second circular supporting hole 55e is formed through an end, on the right side in the drawing, of the second arm part 55c opposite to the first supporting hole 55d.

Furthermore, third and fourth arm parts 56b and 56c are formed in the second arm supporting member 56 so as to extend in a circular-arc shape from both ends of the urging part 56a to the right side in the drawing. The third arm part 56b is arranged adjacent to the first arm part 55b outside thereof, and the fourth arm part 56c is arranged adjacent to the second arm part 55c outside thereof.

Moreover, a third circular supporting hole 56d is formed in the third arm part 56b at a position opposite to the first supporting hole 55d.

Further, a fourth circular supporting hole 56e is formed in the fourth arm part 56c with the same dimension as that of second supporting hole 55e at a position opposite to the second supporting hole 55e of the second arm part 55c.

The head supporting member 54 turns using the first and third supporting holes 55d and 56d and the second and fourth supporting holes 55e and 56e as fulcrums, which support a supporting shaft (not shown) formed on the frame side, such that the thermal head 53 can be moved toward or away from the platen roller 52.

Furthermore, a pair of coils 57 is supported between the head supporting part 55a of the first head supporting member 55 and an urging part 56a of the second head supporting member 56. The urging force of the coil springs 57 enables the thermal head 53, which has been moved down, to be brought into pressure contact with the platen roller 52.

The pair of coil springs 57 is formed to have the same urging force so as to elastically urge the first and second arm parts 55b and 55c, which are equidistant by dimension A from the central position (the central line M) of the head, supporting part 55a in its longitudinal direction, as shown in FIG. 10.

Further, outwardly bent locking parts 55f are respectively formed at predetermined positions of the first and second arm parts 55b and 55c. Each of the locking parts 55f regulates the head supporting part 55a and the urging part 56a, which are urged in a direction to be separated from each other, such that they are not separated from each other over a predetermined dimension.

The printing operation of the conventional thermal printer 51 having the above structure, such as a thermal transfer printer, will now be described. First, the third and fourth arm parts 56b and 56c of the second head supporting member 56 are supported by a head up/down mechanism (not shown).

Then, when the head up/down mechanism is driven to turn the third and fourth arm parts 56b and 56c of the second head supporting member 56 upward, the thermal head 53 is separated from the platen roller 52 and is then moved up.

An ink ribbon (not shown) is drawn between the thermal head 53, which has been moved up, and the platen roller 52. Further, a printing paper (not shown) is fed between the ink ribbon and the platen roller 52.

In such a state, when the head up/down mechanism turns the third and fourth arm parts 56b and 56c of the second head supporting member 56 downward, the first head supporting member 55 also turns downward following the turning of the head up/down mechanism.

This causes the thermal head 53, which has been moved down, to bring the ink ribbon and the printing paper into pressure contact with the platen roller 52.

Thereafter, the printing paper is pulled to the left in the drawing, and the heat generating elements of the thermal head 53 is permitted to generate heat. Then, the ink on the ink ribbon is heat-transferred to the printing paper, and the desired color image is printed thereon.

Further, when the thermal head 53, which has been moved down, is not uniformly brought into pressure contact with the platen roller 52 due to the variation of size between the first and second head supporting members 55 and 56, the other end of the first arm part 55b having the first elongated supporting hole 55d formed therein is moved along the elongated hole to automatically adjust the thermal head 53.

This enables the thermal head 53 to be uniformly brought into pressure contact with the platen roller 52.

In the conventional thermal printer 51 as described above, when the thermal head, which has been moved down, is automatically adjusted, the other end of the first arm part 55b is moved up or down in the drawing. A problem occurs in that such movement causes the contact pressure of the thermal head 53 on the platen roller 52 to be uneven at the first arm part 55b having the first elongated supporting hole 55d therein and at the second arm part 55c, and thus an image blur is generated on a printing paper, resulting in poor printing.

It is considered that the reason why the contact pressure of the thermal head 53 is different at the right and left sides thereof in its longitudinal direction, i.e., at the first and second arm parts 55b and 55c is that the other end of the first arm part 55b is moved along the first elongated supporting hole 55d.

The results of printing tests by such a conventional thermal printer 51 will now be described with reference to FIG. 11. First, the two coil springs 57 are used which have the same urging force of 2 kgf when the thermal head is moved down.

Printing tests are performed in an environment of a normal temperature or a low temperature (0° C.) with four thermal printers (Sample Nos. 1 to 4) in which the coil springs 57 are employed.

In these printing tests, the deflection of the thermal head 53 in the same sample is adjusted with the adjusting screw 55b with three or four stages.

As a result, the urging force of the thermal head 53 on the platen roller 52 when the thermal head has been moved down is approximately 16.3% larger at the second arm part 55c than at the first arm part 55b.

It is also proved that the printing quality in the environment of a low temperature gets worse due to a larger deflection of the head.

### SUMMARY OF THE INVENTION

The present invention is designed to solve the above problems. It is therefore an object of the present invention to provide a thermal printer capable of automatically adjusting a thermal head properly and capable of printing a high-quality image by making the contact pressure of the thermal head on the platen roller uniform.

As first means to achieve the above object, a thermal printer of the present invention comprises a rotatable platen roller; a long thermal head capable of moving toward or away from the platen roller; a first head supporting member having a long head supporting part formed on the side of one end thereof to support the thermal head; and a second head supporting member having a long urging part formed on the side of one end thereof to support an elastic member that elastically urges the head supporting part toward the platen roller. The first head supporting member is provided with first and second arm parts that extend from both ends of the head supporting part in its longitudinal direction to other ends thereof. The second head supporting member is provided with third and fourth arm parts that extend from both ends of the urging part in its longitudinal direction to other ends thereof. The first and second head supporting members are supported such that the other ends can turn in the direction where the thermal head is moved toward or away from the platen roller in a state in which the first and third arm parts are arranged adjacent to each other and the second and fourth arm parts are arranged adjacent to each other. The other end of the first arm part is supported by the other end of the third arm part such that the thermal head can be moved parallel to the direction where the thermal head is moved toward or away from the platen roller. The first arm part of the head supporting part in its longitudinal direction is elastically urged by a first elastic member, and the second arm part thereof is elastically urged by a second elastic member. The urging positions of the first and second elastic members on the head supporting part elastically are positions equidistant from the central position of the head supporting part in its longitudinal direction. The first elastic member has the urging force smaller or larger than the second elastic member.

As second means to achieve the above object, a thermal printer of the present invention comprises a rotatable platen roller; a long thermal head capable of moving toward or away from the platen roller; a first head supporting member having a long head supporting part formed on the side of one end thereof to support the thermal head; and a second head supporting member having a long urging part formed on the side of one end thereof to support an elastic member that elastically urges the head supporting part toward the platen roller. The first head supporting member is provided with first and second arm parts that extend from both ends of the head supporting part in its longitudinal direction to other ends thereof. The second head supporting member is provided with third and fourth arm parts that extend from both ends of the urging part in its longitudinal direction to other ends thereof. The first and second head supporting members are supported such that the other ends can turn in the direction where the thermal head is moved toward or away from the platen roller in which the first and third arm parts are arranged adjacent to each other and the second and fourth arm parts are arranged adjacent to each other. The other end of the first arm part is supported by the other end of the third arm part such that the thermal head can be moved parallel to the direction where the thermal head is moved toward or away from the platen roller. The first arm part of the head supporting part in its longitudinal direction is elastically urged by a first elastic member, and the second arm part thereof is elastically urged by a second elastic member. The first and second elastic members elastically urge the head supporting part with the same urging force. The thermal head has a plurality of heat generating elements formed in the longitudinal direction thereof. The first and second elastic members elastically urge the head supporting part at positions which are at equal distances in a direction perpendicular to a line that connects the central position of the heat generating elements in their longitudinal direction with the supporting part on the other ends of the second and fourth arm parts.

### BRIEF DESCRIPTION OF THE DRAWINGS

FIG. 1 is a perspective view showing a printing section of a thermal printer of the present invention;

FIG. 2 is a plan view of the printing section shown in FIG. 1;

FIG. 3 is a perspective bottom view of the printing section shown in FIG. 1;

FIG. 4 is an exploded perspective view of a head supporting member according to the present invention;

FIG. 5 is an exploded perspective view of the head supporting member according to the present invention;

FIG. 6 is a side view explaining the printing operation of the thermal printer according to the present invention;

FIG. 7 is printing test data of the thermal printer according to the present invention;

FIG. 8 is a plan view explaining another embodiment of the present invention;

FIG. 9 is a perspective view showing a printing section of a conventional thermal printer;

FIG. 10 is a plan view of the printing section shown in FIG. 9; and

FIG. 11 is printing test data obtained by the conventional thermal printer.

### DESCRIPTION OF THE PREFERRED EMBODIMENT

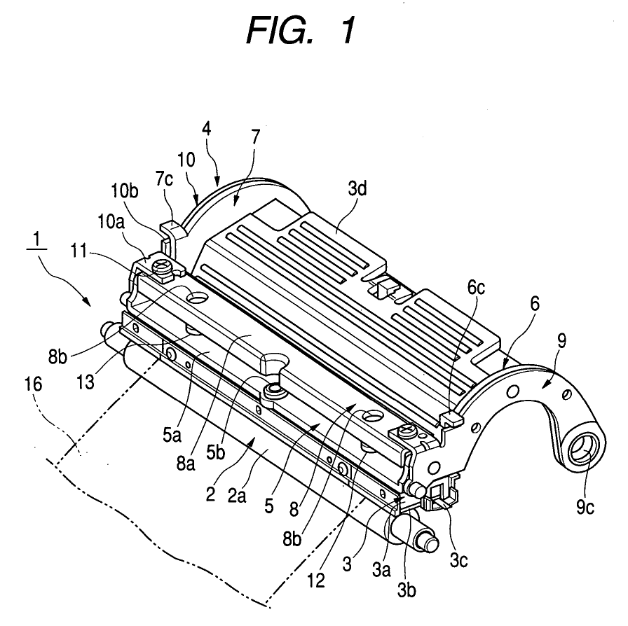

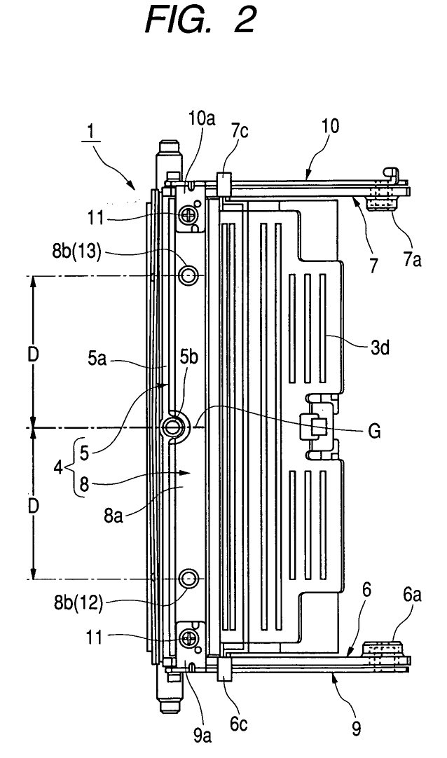

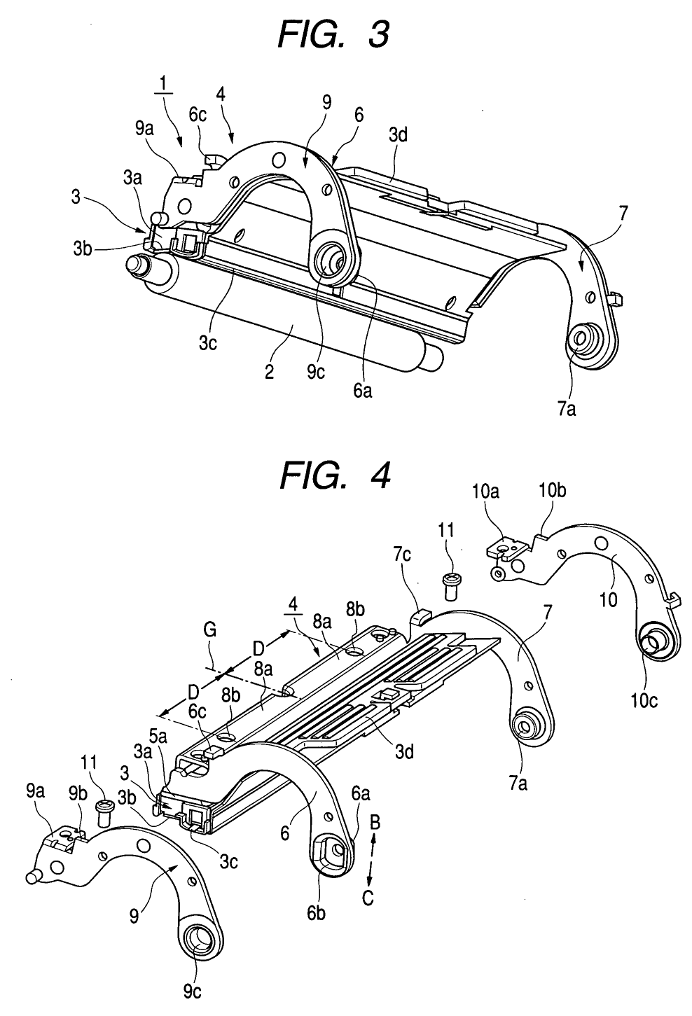

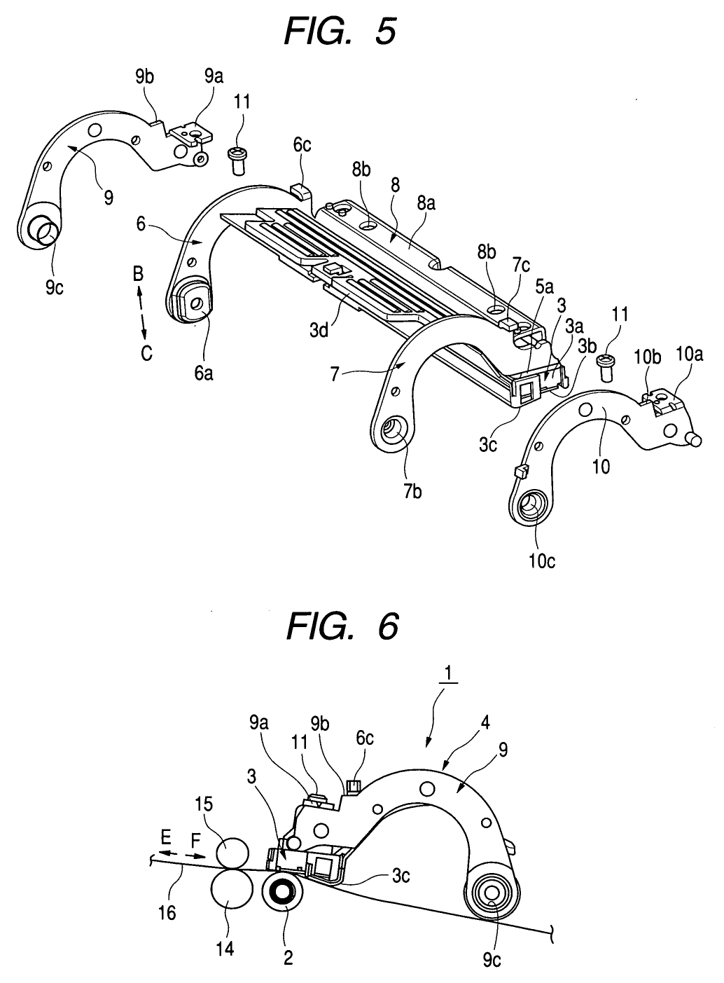

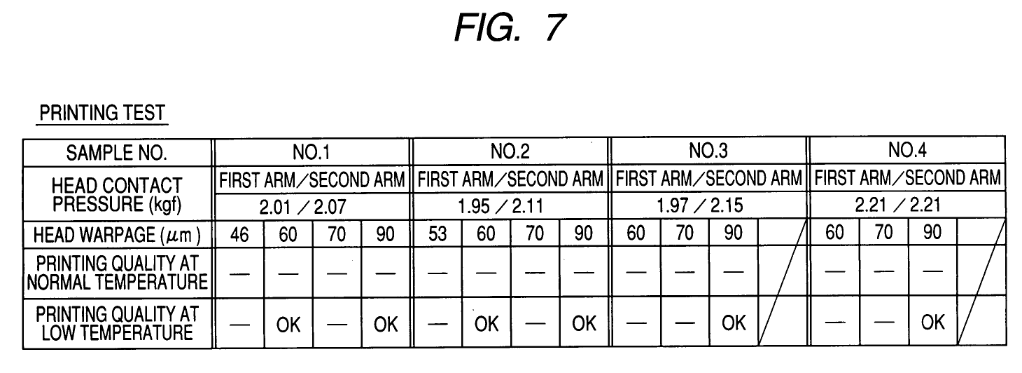

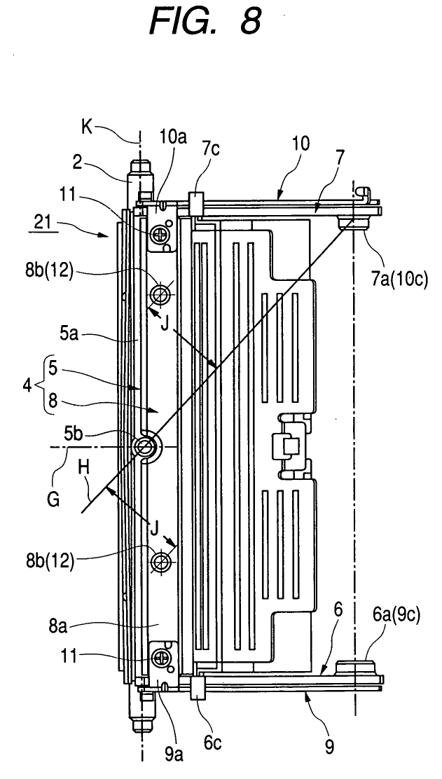

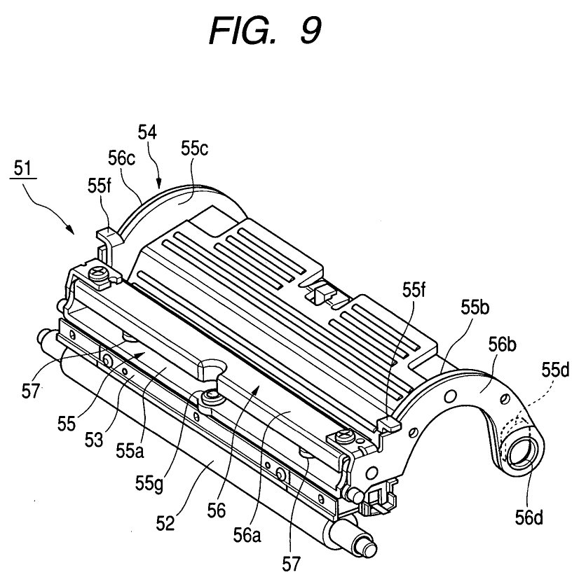

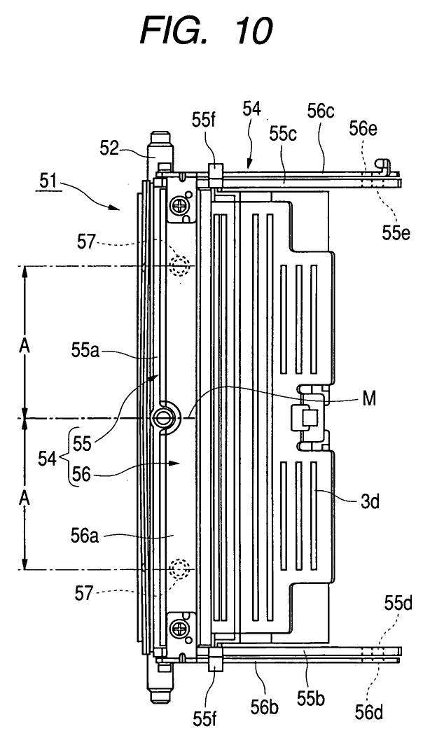

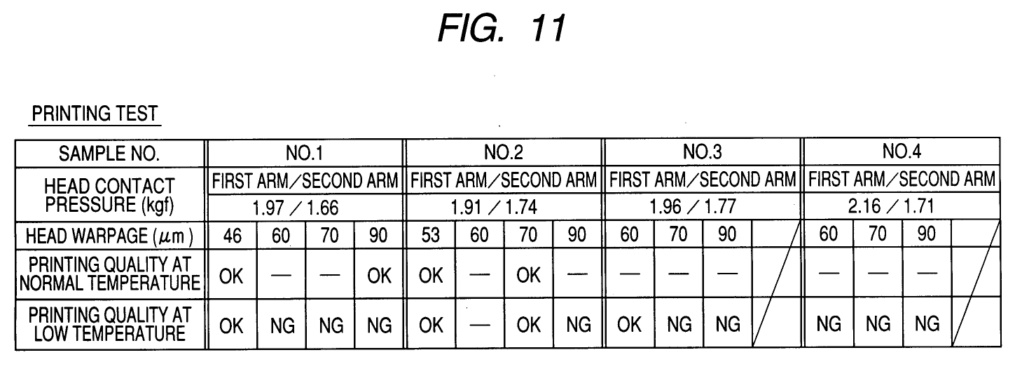

Preferred embodiments of a thermal printer of the present invention will now be described below with reference to the accompanying drawings. FIG. 1 is a perspective view illustrating a thermal printer of the present invention; FIG. 2 is a plan view of the thermal printer shown in FIG. 1; FIG. 3 is a perspective bottom view of the thermal printer shown in FIG. 1; FIGS. 4 and 5 are an exploded perspective view of a head supporting member according to the present invention; FIG. 6 is a side view illustrating the printing operation of the thermal printer according to the present invention; FIG. 7 is printing test data for the thermal printer of the present invention; and FIG. 8 is a plan view for explaining another embodiment of the present invention.

First, a thermal printer 1 according to an embodiment of the present invention is supported on the frame side (not shown). As shown in FIGS. 1 and 3, a cylindrical and long platen roller 2 is rotatably arranged.

The platen roller 2 has a roller part 2a whose outer circumferential part is covered with rubber, etc. A long thermal head 3 composed of a line head is arranged above the roller part 2a such that it can be moved toward or away from (can be moved up or down with respect to) the roller part 2a.

The thermal head 3 is supported by an end of the head supporting member 4 such that it can be moved up or down with respect to the platen roller 2.

Further, the thermal head 3, as shown in FIG. 4, is composed of a head mount 3a and a head substrate 3b. The head mount 3a is fixed to a head supporting part 5a of a first head supporting member 5, which will be described later, by an adhesive and the like. A plurality of heat generating elements (not shown) is formed on the downside of the head substrate 3b so as to protrude along the longitudinal direction of the head substrate 3b.

Also, when the thermal head 3 is moved down, the heat generating elements can be brought into pressure contact with the surface of the platen roller 2.

Further, as shown in FIG. 4, a guide part 3c capable of guiding an ink ribbon (not shown) or a printing paper 14, which will be described later, is formed on the right side of the head substrate 3b in FIG. 4.

Furthermore, a radiating plate 3d is connected to the head substrate 3b so as to extend in the right direction of the drawing. The radiating plate 3d radiates heat generated from the thermal head 3 during printing.

Moreover, the first supporting member 5 having a long head supporting part 5a that supports the thermal head 3 is arranged at one end, on the left side in the drawing, of the head supporting member 4.

Further, in the head supporting member 4, an adjusting screw 5b capable of adjusting the deflection of the thermal head 3 is fixed to a central position (a central line G) of the long head supporting member 5a in its longitudinal direction.

The adjusting screw 5b is tightened to cause the central part of the thermal head 3 in its longitudinal direction to protrude from both the right and left ends thereof in the downward direction of the drawing, which generates the deflection.

On the other hand, when the adjusting screw 5b is loosened, the deflection of the thermal head becomes small. The adjustment of the deflection of the thermal head 3 by the adjusting screw 5b is set to a certain value at the time of the assembly of a printer.

Further, circular-arc-shaped first and second arm parts 6 and 7 are formed in the first head supporting member 5 such that they extend from both ends, on the side nearer to an observer (hereinafter, referred to as ‘near side’) and on the side farther from an observer (hereinafter, referred to as ‘far side’) in the drawing, of the long head supporting part 5a in its longitudinal direction to the other ends, on the right side in the drawing, of the head supporting part 5a.

The first head supporting member 5 comprising the head supporting part 5a and the first and second arm parts 6 and 7 of, as shown in FIG. 2, is substantially formed in a U-shape in plan view.

Further, a first supporting part 6a is formed in the other end, on the right side of FIG. 4, of the first arm part 6 so as to be deep-drawn to protrude toward the second arm part 7. The first supporting part 6a has a first supporting hole 6b with a predetermined depth formed therein.

The first supporting hole 6b is formed in the shape of a hole that is elongated in the directions of arrows B and C in which the thermal head 3 is moved toward or away from the platen roller 2.

Furthermore, the first arm part 6 is provided with a locking part 6c formed by outwardly bending the upper outer circumferential edge of the first arm part 6 near one end of the first head supporting member 5 in which the head supporting part 5a is formed.

Moreover, the other end, on the right side of FIG. 4, of the second arm part 7 is provided with a second supporting part 7a that is deep-drawn to protrude toward the first arm part 6. The second supporting part 7a is formed in a cylindrical shape, and has a second circular supporting hole 7b with a predetermined depth formed therein. In addition, the second arm part 7 is provided with a locking part 7c formed by outwardly bending the upper outer circumferential edge of the second arm part 7 near one end of the first head supporting member 5 in which the head supporting part 5a is formed.

The respective locking parts 6c and 7c of the first and second arm parts 6 and 7 are formed to face outward.

A second head supporting member 8 having an urging part 8a that is arranged on the upper side of the head supporting part 5a of the first head supporting member 5 formed as such is combined with the first head supporting member 5, thereby forming the head supporting member 4.

In the second head supporting member 8, the long urging part 8a is arranged on the upper side of the head supporting part 5a of the first head supporting member 5 at a predetermined gap.

Supporting holes 8b capable of supporting first and second elastic members 12 and 13, which will be described later, are formed at equal distances D from the central position (the central line G) of the urging part 8a in its longitudinal direction.

The urging part 8a is made of a long metal material, and has third and fourth arm parts 9 and 10 respectively fixed to both ends, on the near and far sides in the drawing, of the urging part 8a in its longitudinal direction such that the second head supporting member 8 is substantially formed in a U-shape in plan view, similar to the first head supporting member 5.

The third arm part 9 is formed such that its other end extends on the right side of the drawing in a state where it is positioned adjacent to the first arm part 6 outside thereof. The fourth arm part 10 is formed such that its other end extends on the right side of the drawing in a state it is positioned adjacent the second arm 7 outside thereof.

Remaining parts 9a and 10a are formed by inwardly bending ends of the third and fourth arm parts 9 and 10 on the left side of the drawing so as to be opposite to each other. Both ends of the urging part 8a in its longitudinal direction are respectively fixed to the remaining parts 9a and 10a with small screws 11, which are integrated in a substantially U-shape in plan view.

Further, the third arm part 9 has a flat stopper part 9b formed at the upper outer circumferential part thereof near the remaining part 9a. The locking part 6c of the first arm part 6 can abut on the stopper part 9b.

Furthermore, a third cylindrical supporting part 9c is formed at the other end of the third arm part 9, on the right side of the drawing, so as to protrude toward the first arm part 6 with a predetermined dimension.

The third cylindrical supporting part 9c is formed to have an outer diameter slightly smaller than the width of the first supporting hole 6b in its horizontal direction such that it can be fitted into the first supporting hole 6b.

Then, when the first long supporting hole 6b of the first arm part 6 is fitted on the third supporting part 9c whose cylindrical inner diametrical part is fitted on a supporting shaft (not shown) on the frame side, the first arm part 6 is supported such that the first supporting part 6a thereof can be moved up or down in the direction of the arrow B or C.

Also, the first arm part 6 can rotate together with the third arm part 9 since the first supporting part 6a is supported by the third supporting part 9c. Further, a fourth cylindrical supporting part 10c is formed at the other end of the fourth arm part 10 so as to protrude toward the second arm part 7 with a predetermined dimension.

Then, when the second cylindrical supporting hole 7b of the second arm part 7 is fitted on the fourth supporting part 10c whose cylindrical inner diametrical part is fitted on a supporting shaft (not shown) on the frame side, the second arm part 7 can integrally rotate with the fourth arm part 10 using the fourth supporting part 10c as a fulcrum since the second supporting part 7a is rotatably supported by the fourth supporting part 10c.

Further, the first and second elastic members 12 and 13 each composed of a compressive coil spring and the like are supported within two supporting holes 8b of the urging part 8a in the space between the head supporting part 5a and the urging part 8a of the first and second head supporting members 5 and 8, so that the head supporting part 5a and the urging part 8a are elastically urged away from each other.

At this time, the first and second supporting members 5 and 8 are arranged such that the stopper parts 9b and 10b abut on the locking part 6c and 7c, respectively.

Further, the first and second elastic members 12 and 13 arranged between the head supporting part 5a and the urging part 8a are disposed such that the first elastic member 12 is supported on the side of the first arm part 6 and the second elastic member 13 is supported on the side of the second arm part 7.

Then, the first and second elastic members 12 and 13 are arranged between the head supporting part 5a and the urging part 8a at positions equidistant by the dimension D from the central position (the central line G) of the head supporting part 5a in its longitudinal direction, thereby elastically urging the head supporting part 5a toward the platen roller 2.

The urging force of the first elastic member 12 is smaller than that of the second elastic member 13 by 20 to 25%.

The head supporting member 4 having the above structure is formed such that the third supporting part 9c of the third arm part 9 is fitted into the first supporting hole 6b of the first arm part 6 and the fourth supporting part 10c of the fourth arm part 10 is fitted into the second supporting hole 7b of the second arm part 7.

The first and second elastic members 12 and 13 are arranged in the space between the head supporting part 5a and the urging part 8a. The urging force of the first and second elastic members 12 and 13 is regulated such that the stopper parts 9b and 10b of the third and fourth arm parts 9 and 10 respectively abut on the locking parts 6c and 7c of the first and second arm parts 6 and 7 so as not to increase the dimension between the head supporting part 5a and the urging part 8a over a predetermined value.

This allows the first and second head supporting members 5 and 8 to be integrated with each other and thereby the head supporting member 4 is assembled as a group of half-finished goods.

In the head supporting member 4 obtained as a group of half-finished goods by integrating the first and second supporting members 5 and 8 with each other in such way, supporting shafts (not shown) supported by the frame of the printer are respectively fitted into the inner diametrical part of the third supporting part 9c of the third arm part 9 and the inner diametrical part of the fourth supporting part 10c of the fourth arm part 10. Therefore, one end of the head supporting member 4 supporting the thermal head 3 can freely rotate using the supporting parts 6a, 7a, 9c and 10c on the side of the other end of the head supporting member 4 as a fulcrum.

Further, in the head supporting member 4, the third and fourth arm parts 9 and 10 are supported by a head up/down mechanism (not shown). Therefore, the thermal head 3 on the side of one end of the head supporting member 4 can be moved up or down with respect to the platen roller 2 by driving the head up/down mechanism.

When the head up/down mechanism allows the thermal head 3 to move up or down to be brought into pressure contact with the platen roller 2, the first supporting part 6a of the first arm part 6 is moved up or down in the direction of the arrow B or C by the urging force of the elastic member 12, so that the thermal head 3 is automatically adjusted.

Also, the automatically adjusted thermal head 3 is adapted to be uniformly brought into pressure contact with the roller part 2a of the platen roller 2.

Further, in the thermal printer 1 of the present invention, as shown in FIG. 6, a paper feed roller 14 and a pressure contact roller 15 are arranged near the left side of the platen roller 2.

Furthermore, a printing paper 16 is fed in the direction of arrow E in the drawing between the platen roller 2 and the thermal head 3 that has been moved up. The printing paper 16 can be reciprocally carried in the direction of the arrow E or F by the clockwise rotation or counterclockwise rotation of the paper feed roller 14 in the state where the printing paper 16 is inserted and pressed between the paper feed roller 14 and the pressure contact roller 15.

The printing operation of the thermal printer 1 of the present invention having the above structure will now be described. First, an ink ribbon (not shown) is drawn between the platen roller 2 and the thermal head 3, which has been moved up by turning the head supporting member 4 upward with the head up/down mechanism.

Further, the printing paper 16 is fed between the ink ribbon and the platen roller 2, and is then pressed between the paper feed roller 14 and the pressure contact roller 15.

In this state, as shown in FIG. 6, the thermal head 3 is moved down to bring the ink ribbon and the printing paper 16 into pressure contact with the platen roller 2. Then, the first and second elastic members 12 and 13 having different urging forces permit the thermal head 3 to be brought into pressure contact with the platen roller 2 via the ink ribbon and the printing paper 16. At this time, the contact pressure of the thermal 3 on the platen roller 2 is substantially the same at the first and second arm parts 6 and 7 as can be seen from the results of printing tests, which will be described later, as shown in FIG. 7, because the first supporting part 6a of the first arm part 6 is moved in the direction of the arrow B or C to automatically adjust the thermal head 3.

Due to the above, the ink ribbon and the printing paper 16 can be uniformly brought into pressure contact with the platen roller 2 in its longitudinal direction.

Next, the plurality of heat generating elements is permitted to generate heat based on printing information, and the paper feed roller 14 rotates to pull the printing paper 16 in the direction of the arrow E, so that the ink on the ink ribbon is heat-transferred onto the printing paper 16 to print a desired color image thereon.

Then, the printing paper 16 after printing is carried in the direction of the arrow E or is fed back in the direction of the arrow F with the thermal head 3 moved up such that it is discharged to the outside of the printer.

The results of printing tests by such a thermal printer 1 of the present invention will now be described with reference to FIG. 7. The same sample as the printer used to prove the conventional problems was used as a printer for the present printing test, and the conventional coil springs 57 having the same urging force were replaced with the first and second elastic members 12 and 13 according to the present invention, whose urging forces are different from each other.

Also, the urging force of the first elastic member 12 was set to about 2 kgf, and the urging force of the second elastic member 13 was set to about 2.5 kgf.

Further, the deflection of the thermal head 3 was adjusted by adjusting the adjusting screw 5b with three to four stages, similar to the conventional structure. However, in the present test, only a test in a severe environment at a low temperature of 0° C. was performed, and the test in an environment at a normal temperature was omitted in consideration of the conventional results of printing tests.

In addition, according to the printing test of the thermal printer of the present invention, a result was obtained that the contact pressure of the thermal head 3 on the platen roller 2 is almost the same at the first and second arm parts 6 and 7 irrespective of the difference in the urging force of about 0.5 kgf between the first and second elastic members.

Further, even if the deflection of the head is adjusted to the maximum dimension of 90 μm with the adjusting screw 5b in any of the samples, printing blurring and the like does not occur on an image printed on the printing paper 16, thereby achieving a high-quality printing.

In other words, in the thermal printer having a structure in which the first supporting part 6a of the first arm part 6 is moved up or down to automatically adjust the thermal head 3, it is proved that, in the present test, the urging force of the first elastic member 12 is smaller than that of the second elastic member 13 by 20 to 25% such that the head contact pressure on the side of the first and second arm parts 6 and 7 becomes almost the same.

In the first and second elastic members 12 and 13 in the present test, the urging force of the second elastic member 13 is set to be smaller than that of the first elastic member 12, and the portion of the head supporting part 5a nearer than the distance from the first to fourth supporting parts 6a, 7a, 9c, and 10c to the heat generating elements (a position that is brought into pressure contact with the platen roller 2) of the thermal head 3 is biased.

On the contrary, in the first and second elastic members 12 and 13 in the present test, the urging force of the second elastic member 13 may be set to be larger than that of the first elastic member 12, and the portion of the head supporting part 5a remoter than the distance from the first to fourth supporting parts 6a, 7a, 9c, and 10c to the heat generating elements of the thermal head 3 may be urged.

In other words, according to the present invention, the urging force of the first elastic member 12 is set to be smaller or larger than that of the second elastic member 13 depending on the position of the head supporting member 5a urged by the first and second elastic members 12 and 13. Therefore, the contact pressure of the thermal head 3 on the platen roller 2 can be uniform.

Further, a thermal printer 21 according to another embodiment of the present invention will now be described with reference to FIG. 8. First, the first elastic members 12 having the same urging force are used as a pair of elastic members.

In addition, the first and second urging members 12 and 13 may elastically urge portions of the head supporting part 5a with the same distance J in a direction perpendicular to a line H that connects the central position (the central line G) (on the central line K of the platen roller 2 in FIG. 8) of the heat generating elements, which are formed along the longitudinal direction of the thermal head 3, to the second and fourth supporting parts 7a and 10c in a state where the other ends of the second and fourth arm parts 7 and 10 are connected to each other.

As such, the thermal printer 21 of the modification of the present invention makes it possible to uniform the contact pressure of the thermal head 3 on the platen roller 2 by using a pair of the first elastic members 12 having the same urging force even if the distance from the central line G to the first elastic member 12 on the side of the first arm part 6 is shorter than the distance from the central line G to the first elastic member 12 on the side of the second arm part 7 and thus the first supporting part 6a of the first arm part 6 is moved by the automatic adjustment of the thermal head 3.

Moreover, although the embodiment of the present invention and another embodiment thereof describe that the first arm part 6 of the first head supporting member 5 is arranged on the lower side, that is, the near side in the drawing and the second arm part 7 is arranged on the upper side, that is, the far side in the drawing, the second arm part 7 may be arranged on the near side in the drawing, and the first arm part 6 may be arranged on the far side in the drawing.

In other words, the near side in the drawing may be rotatably supported, and the thermal head 3 may move up or down so as to be automatically adjusted.

Further, although it has been described that compressive coil springs are employed as the first and second elastic members 12 and 13, the first and second elastic members 12 and 13 may comprise a hard sponge, an elastic rubber, and the like.

Furthermore, although it has been described that a heat transfer printer using an ink ribbon is employed as the thermal printer 1 of the present invention, only the printing paper 16 composed of, for example, a thermosensitive paper may be employed without using the ink ribbon.

In the thermal printer of the present invention, the first and second elastic members elastically urge the head supporting part at the positions equidistant from the central position of the head supporting part in its longitudinal direction, and the urging force of the first elastic member is set to be smaller or larger than that of the second elastic member. Therefore, even in a structure in which the thermal head is automatically adjusted, the contact pressure of the thermal head on the platen roller can be uniform at the first and second arm parts.

Due to the above, it is possible to provide a thermal printer capable of performing high-quality printing without any trouble, such as blurred printing.

Further, the first and second urging members elastically urge the head supporting part with the same urging force, and the thermal head has a plurality of heat generating elements formed in the longitudinal direction thereof. In addition, the first and second elastic members elastically urge portions of the head supporting part with the same distance in a direction perpendicular to a line that connects the central position of the heat generating elements in its the longitudinal direction with the supporting parts on the other ends of the second and fourth arm parts. Hence, the contact pressure of the thermal head on the platen roller can be the same at the first and second arm parts.

Further, since the urging forces of the first and second elastic members are the same, the efficiency of assembly can be improved.

1. A thermal printer comprising:
a rotatable platen roller;
a long thermal head capable of moving toward or away from the platen roller;
a first head supporting member having a long head supporting part formed on a side of one end thereof to support the thermal head; and
a second head supporting member having a long urging part formed on a side of one end thereof to support an elastic member that elastically urges the head supporting part toward the platen roller,
wherein the first head supporting member is provided with first and second arm parts that extend from both ends of the head supporting part in its longitudinal direction to other ends thereof,
wherein the second head supporting member is provided with third and fourth arm parts that extend from both ends of the urging part in its longitudinal direction to other ends thereof,
wherein the first and second head supporting members are supported such that the other ends can turn in a direction where the thermal head is moved toward or away from the platen roller in a state in which the first and third arm parts are arranged adjacent to each other and the second and fourth arm parts are arranged adjacent to each other,
wherein the other end of the first arm part is supported by the other end of the third arm part such that the thermal head can be moved parallel to the direction where the thermal head is moved toward or away from the platen roller,
wherein the first arm part of the head supporting part in its longitudinal direction is elastically urged by a first elastic member, and the second arm part thereof is elastically urged by a second elastic member,
wherein urging positions of the first and second elastic members on the head supporting part are positions equidistant from a central position of the head supporting part in its longitudinal direction; and
wherein the first elastic member has the urging force smaller than the second elastic member.

2. A thermal printer comprising:
a rotatable platen roller;
a long thermal head capable of moving toward or away from the platen roller;
a first head supporting member having a long head supporting part formed on a side of one end thereof to support the thermal head; and
a second head supporting member having a long urging part formed on a side of one end thereof to support an elastic member that elastically urges the head supporting part toward the platen roller,
wherein the first head supporting member is provided with first and second arm parts that extend from both ends of the head supporting part in a longitudinal direction to other ends thereof,
wherein the second head supporting member is provided with third and fourth arm parts that extend from both ends of the urging part in its longitudinal direction to other ends thereof,
wherein the first and second head supporting members are supported such that the other ends can turn in a direction where the thermal head is moved toward or away from the platen roller in a state in which the first and third arm parts are arranged adjacent to each other and the second and fourth arm parts are arranged adjacent to each other,
wherein the other end of the first arm part is supported by the other end of the third arm part such that the thermal head can be moved parallel to the direction where the thermal head is moved toward or away from the platen roller,
wherein the first arm part of the head supporting part in its longitudinal direction is elastically urged by a first elastic member, and the second arm part thereof is elastically urged by a second elastic member,
wherein the first and second elastic members elastically urge the head supporting part with the same urging force,
wherein the thermal head has a plurality of heat generating elements formed in the longitudinal direction thereof, and
wherein the first and second elastic members elastically urge the head supporting part at positions which are at equal distances in a direction perpendicular to a line that connects a central position of the heat generating elements in their longitudinal direction with the supporting part on the other ends of the second and fourth arm parts.

3. A thermal printer comprising:
a rotatable platen roller;
a long thermal head capable of moving toward or away from the platen roller;
a first head supporting member having a long head supporting part formed on a side of one end thereof to support the thermal head; and
a second head supporting member having a long urging part formed on a side of one end thereof to support an elastic member that elastically urges the head supporting part toward the platen roller,
wherein the first head supporting member is provided with first and second arm parts that extend from both ends of the head supporting part in its longitudinal direction to other ends thereof,
wherein the second head supporting member is provided with third and fourth arm parts that extend from both ends of the urging part in its longitudinal direction to other ends thereof,
wherein the first and second head supporting members are supported such that the other ends can turn in a direction where the thermal head is moved toward or away from the platen roller in a state in which the first and third arm parts are arranged adjacent to each other and the second and fourth arm parts are arranged adjacent to each other,
wherein the other end of the first arm part is supported by the other end of the third arm part such that the thermal head can be moved parallel to the direction where the thermal head is moved toward or away from the platen roller,
wherein the first arm part of the head supporting part in its longitudinal direction is elastically urged by a first elastic member, and the second arm part thereof is elastically urged by a second elastic member,
wherein urging positions of the first and second elastic members on the head supporting part are positions equidistant from a central position of the head supporting part in its longitudinal direction; and
wherein the first elastic member has the urging force larger than the second elastic member.
